(19) United States
(12) Patent Application Publication
(10) Pub. No.: US 2020/0058012 A1
(43) Pub. Date: Feb. 20, 2020

(54) SYSTEM, COMPUTER-READABLE MEDIA AND COMPUTER-IMPLEMENTED METHOD FOR AUTOMATED, MULTI-ACCOUNT PURCHASE CONTROL

(71) Applicant: Mastercard International Incorporated, Purchase, NY (US)

(72) Inventors: Priyanka Chandorkar, Pune (IN); Priyanka Pandey, Pune (IN); Neeta Lopes, Chesterfield, MO (US)

(73) Assignee: Mastercard International Incorporated, Purchase, NY (US)

(21) Appl. No.: 16/105,205

(22) Filed: Aug. 20, 2018

(51) Int. Cl. G06Q 20/22; G06Q 20/40

(52) U.S. Cl. CPC G06Q 20/227; G06Q 20/401

(57) ABSTRACT

A multi-account payment system includes a memory device and a processor. The processor is programmed to receive a designation of a plurality of account numbers associated with a primary cardholder for control by a multi-account application of the multi-account payment system. The processor is programmed to receive a request from the primary cardholder to create one or more limitations on the use of the plurality of account numbers, and to store the plurality of account numbers and the one or more limitations in the memory device. The processor is further configured to receive a transaction authorization message associated with a transaction by one of the plurality of account numbers, determine whether the transaction violates at least one of the one or more limitations, and decline the transaction if one or more of the limitations are violated.

### FIELD OF THE DISCLOSURE

The present disclosure generally relates to systems, computer-readable media and computer-implemented methods for automatically controlling purchases across multiple cardholder accounts.

### BACKGROUND OF THE DISCLOSURE

Budgeting traditionally requires knowledge and self-control to be exercised by a cardholder at every purchase. For instance, the cardholder may slavishly work to record expenses in a budget tracking tool, and may consult the tool periodically to determine which expenditures might exceed a budget limit.

Existing technologies do not scale well for application to household budgets implicating multiple people using multiple payment instruments. As an example, traditional technologies rely on the good faith and motivation of each member of a household in keeping transaction records and observing established budget limit(s). Such reliance may be misplaced in many cases.

### BRIEF DESCRIPTION OF THE DISCLOSURE

This summary is not intended to identify essential features of the present disclosure and is not intended to be used to limit the scope of the claims. These and other aspects of the present disclosure are described below in greater detail.

In one aspect, a multi-account payment system for controlling transaction authorization(s) is provided. The multi-account payment system includes a memory device for storing data, and a processor communicatively coupled to the memory device. The processor is programmed to receive a designation of a plurality of account numbers associated with a primary cardholder for control by a multi-account application of the multi-account payment system. The processor is programmed to receive a request from the primary cardholder to create one or more limitations on the use of the plurality of account numbers, and to store the plurality of account numbers and the one or more limitations in the memory device. The processor is further configured to receive a transaction authorization message associated with a transaction by one of the plurality of account numbers, determine whether the transaction violates at least one of the one or more limitations, and decline the transaction if one or more of the limitations are violated. The system may include additional, less, or alternate functionality, including that discussed elsewhere herein.

In another aspect, a computer-implemented method for controlling transaction authorization(s) is provided. The method includes receiving designation of a plurality of account numbers associated with a primary cardholder for control by a multi-account application of the multi-account payment system; receiving a request from the primary cardholder to create one or more limitations on the use of the plurality of account numbers; storing the plurality of account numbers and the one or more limitations in the memory device; receiving a transaction authorization message associated with a transaction by one of the plurality of account numbers; determining whether the transaction violates at least one of the one or more limitations; and, declining the transaction if one or more of the limitations are violated. The method may include additional, less, or alternate actions, including those discussed elsewhere herein.

In still another aspect, a system comprising computer-readable media for controlling transaction authorization(s) may be provided. The system may include a non-transitory computer-readable medium with a program stored thereon, wherein the program instructs a hardware processing element of a mobile electronic device to: receive a designation of a plurality of account numbers associated with a primary cardholder for control by a multi-account application of the multi-account payment system; receive a request from the primary cardholder to create one or more limitations on the use of the plurality of account numbers; store the plurality of account numbers and the one or more limitations in the memory device; receive a transaction authorization message associated with a transaction by one of the plurality of account numbers; determine whether the transaction violates at least one of the one or more limitations; and, decline the transaction if one or more of the limitations are violated. The program(s) stored on the computer-readable media may instruct the processing elements to perform additional, fewer, or alternative actions, including those discussed elsewhere herein.

### BRIEF DESCRIPTION OF THE DRAWINGS

Embodiments of the present disclosure are described in detail below with reference to the attached drawing figures, wherein:

FIG. 1 is a block diagram of an example multi-party payment card network system having a multi-account payment system;

FIG. 2 is a simplified block diagram of an example transaction processing system (TPS) for providing access to and controlling transactions by the plurality of account numbers using the multi-account payment system shown in FIG. 1;

FIG. 3 is an example configuration of a user system operated by a user, such as a cardholder of the multi-party payment card network system shown in FIG. 1;

FIG. 4 is an example configuration of a server system, such as a server system for use in an interchange network; and

FIG. 5 is a flow chart of an example method for controlling transaction authorization across multiple account numbers.

The figures are not intended to limit the present disclosure to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. It is contemplated that the disclosure has general application to identifying and verifying entities requesting access to confidential information and/or financial services. The scope of the present disclosure is defined only by the appended claims, along with the full scope of equivalents to which such claims are entitled.

In this description, references to “one embodiment,” “an embodiment,” or “embodiments” mean that the feature or features referred to are included in at least one embodiment of the disclosure. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present disclosure can include a variety of combinations and/or integrations of the embodiments described herein.

Broadly characterized, the present disclosure relates to systems and methods for controlling transaction authorizations made via a plurality of accounts managed by a multi-account application. Transactions may be controlled and/or limited by transaction type. Exemplary transaction types may be classified according to merchants, merchant types—such as grocery stores, liquor stores, clothing stores, restaurants, and the like—and/or with reference to the account(s) used to perform the transaction(s), as discussed in more detail below. The multi-account application may also be configured to control and/or limit transactions by types classified according to authorized account cardholder. For instance, multiple cardholders may be authorized to use at least one of the account(s) managed by the multi-account application, and the application may be configured to manage transactions based at least in part on the transacting cardholder.

More particularly, the disclosed embodiments provide a system, computer-readable medium and computer-implemented method for placing and enforcing limitations on transactions conducted via a plurality of account numbers. The disclosed embodiments may also include a primary cardholder establishing at least one shared account number from among the plurality of account numbers, and transmitting the shared account number(s) to a secondary cardholder.

In one example embodiment, a multi-account payment system is configured for use with a payment card processing network such as, for example, an interchange network. The multi-account payment system includes a memory device and a processor in communication with the memory device. The processor is programmed to receive a designation of a plurality of account numbers for control by the multi-account payment system, and to implement control and/or enforcement of transaction limitations on the plurality of account numbers. The processor may also be configured to receive a designation of at least one of the plurality of account numbers as a shared account number. The multi-account payment system may link a primary cardholder to the shared account number(s), add a secondary cardholder to the shared account number(s), and receive use limitations on the plurality of account numbers (including the shared account number) from the cardholder(s).

When the primary cardholder makes transactions using any of the plurality of account numbers, and/or the secondary cardholder makes transactions using the shared account number(s), the primary cardholder and/or the secondary cardholder may receive notifications from the multi-account payment system. The notifications may include the details of the transactions, the relationship between the transactions and related transaction limitations, or the like. Notifications relating to account status, including notifications relating account status to applicable transaction limit(s), may also or alternatively be provided independently of the occurrence of transactions, for example via updates provided according to fixed time intervals.

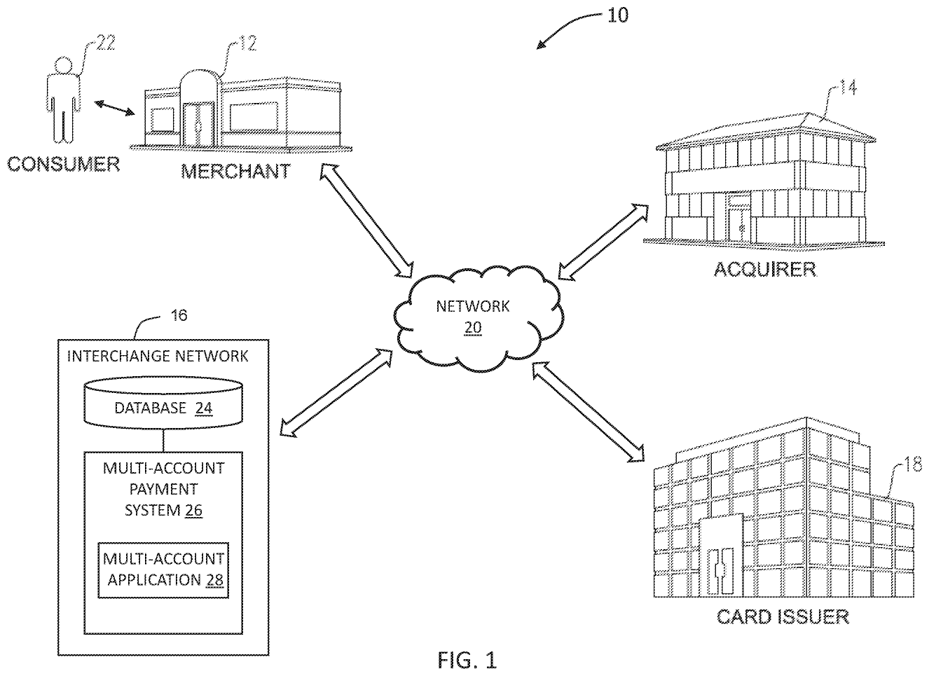

FIG. 1 is a block diagram of an example multi-party payment card network system 10 having a multi-account payment system 26. The payment card network system 10 facilitates providing interchange network services offered by an interchange network 16. In addition, the payment card network system 10 enables payment card transactions in which merchants 12, acquirers 14, and/or card issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc.

In the example embodiment, the payment card network system 10 generally includes the merchants 12, the acquirers 14, the interchange network 16, and the issuers 18, coupled in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and the consumers 22, etc.

Embodiments described herein may relate to a transaction card system, such as a credit card payment system using the Mastercard® interchange network. (MASTERCARD® is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, “financial transaction data” includes a unique account number associated with an account holder using a payment card issued by an issuer, purchase data representing a purchase made by the cardholder, including a type of merchant, amount of purchase, date of purchase, account balance(s), and other data, which may be transmitted between any parties of multi-party payment card network system 10.

In a typical transaction card system, a financial institution called the “issuer” issues a transaction card, such as a credit card, to a cardholder or consumer 22, who uses the transaction card to tender payment for a purchase from the merchant 12. In the example embodiment, the merchant 12 is typically associated with products, for example, and without limitation, goods and/or services, that are offered for sale and are sold to the consumers 22. The merchant 12 includes, for example, a physical location and/or a virtual location. A physical location includes, for example, a brick-and-mortar store, etc., and a virtual location includes, for example, an Internet-based store-front.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 22 presents payment for a purchase with, for example, a transaction card, a digital wallet, and the like, the merchant 12 requests authorization from the acquirer 14 for the amount of the purchase. The request may be performed over the telephone but is usually performed through the use of a point-of-sale terminal that reads the cardholder's account information from a magnetic stripe, a chip, or embossed characters on the transaction card and/or wirelessly via the digital wallet and communicates electronically with the transaction processing computers of the acquirer 14. Alternatively, the acquirer 14 may authorize a third party to perform transaction processing on its behalf In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

When a request for authorization is accepted, the available credit line of the cardholder's account is decreased. Normally, a charge for a payment card transaction is not posted immediately to the cardholder's account because bankcard associations, such as Mastercard International Incorporated, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 22 cancels a transaction before it is captured, a “void” is generated. If the cardholder 22 returns goods after the transaction has been captured, a “credit” is generated. The interchange network 16 and/or the issuer 18 stores the transaction card information, such as, and without limitation, a type of merchant, a merchant identifier, a location where the transaction was completed, an amount of purchase, and a date and time of the transaction, in a database 24.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as financial transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12.

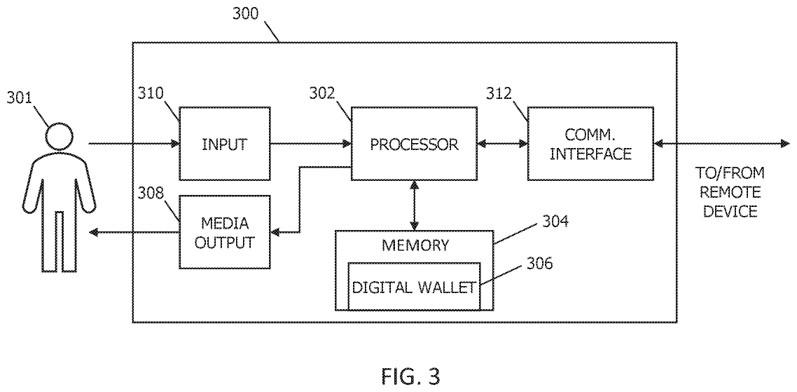

In some embodiments, the payment card transaction is a card-not-present transaction conducted, for example, with a payment card and/or virtual payment account number (virtual PAN) stored as digital wallet data in an electronic wallet or digital wallet 306 (shown in FIG. 3). The interchange network 16 includes the multi-account payment system 26, which is configured to analyze various data associated with the payment card transaction and provide various information to one or more parties involved in the payment card transaction, such as the merchant 12 and the acquirer 14.

More particularly, the multi-account payment system 26 is a specially programmed computer system that enables the interchange network 16 to receive, store, and/or transmit the following: (a) data related to a plurality of accounts, including a shared primary account number (PAN) and/or a shared virtual PAN; (b) notifications associated with the plurality of accounts; and/or (c) user-selected limitations associated with the plurality of accounts. The multi-account payment system 26 includes a multi-account application 28 that facilitates communication between the multi-account payment system 26 and one or more authorized users or consumers 22 (shown in FIG. 1) of the plurality of account numbers, preferably via the user's digital wallet 306.

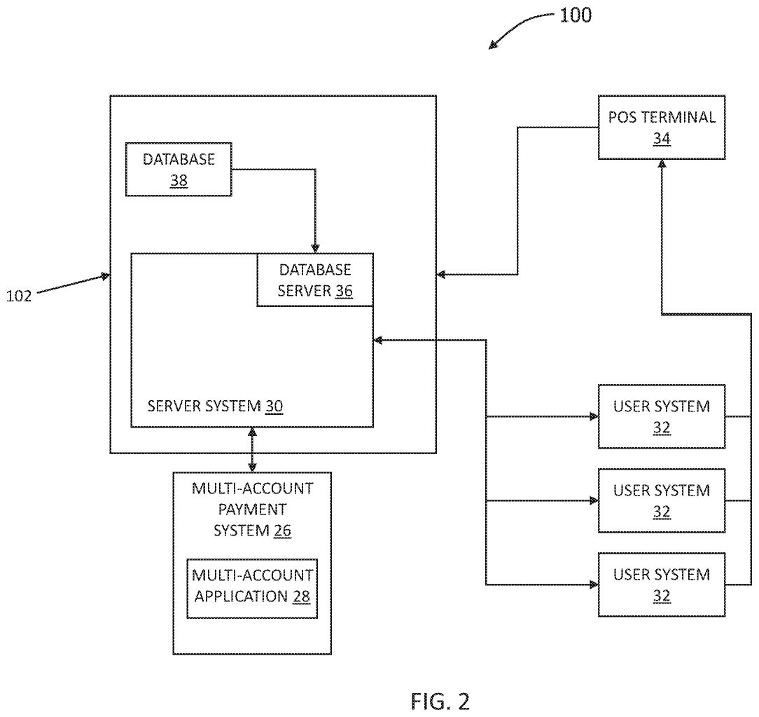

FIG. 2 is a simplified block diagram of an example transaction processing system (TPS) 102 for providing users 301 (shown in FIG. 3) and/or user computing devices 300 with financial transaction data and access to at least one of the plurality of account numbers, including a shared PAN and/or virtual PAN, using the multi-account payment system 26. In some embodiments, the payment network 100 is similar to the payment card network system 10 (shown in FIG. 1). In the example embodiment, the payment network 100 includes a plurality of computing devices connected in accordance with the present disclosure. The payment network 100 includes a server system 30 of the TPS 102 in communication with a point-of-sale (POS) terminal 34 at a merchant location 12 (shown in FIG. 1), and a plurality of user systems 32 associated with cardholders 22 (i.e., consumers).

More specifically, in the example embodiment, the TPS 102 includes the server system 30 of, for example, the interchange network 16 (shown in FIG. 1), in communication with the POS terminal 34 and the user systems 32 associated with the consumers 22. In one embodiment, the user systems 32 are mobile computing devices including a digital wallet, such as mobile phones, Smartphones, personal digital assistants (PDAs), key fobs, and/or computers, such that server system 30 is accessible to the user systems 32 using the Internet. The user systems 32 are interconnected to the Internet through one or more of many interface types including, for example, a network, such as a wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like. The user systems 32 could be any device capable of interconnecting to the Internet including an Internet connected phone, a PDA, or any other suitable web-based connectable equipment.

In the example embodiment, the TPS 102 also includes one or more POS terminals 34, which may be connected to the user systems 32 and may be connected to the server system 30. The POS terminals 34 may be interconnected to the Internet (or any other network that allows the POS terminals 34 to communicate as described herein) through many interfaces including a network, such as a local area network (LAN) or a wide area network (WAN), dial-in-connections, cable modems, wireless modems, and special high-speed ISDN lines. The POS terminals 34 are any device capable of interconnecting to the Internet and including an input device capable of reading information from a cardholder's financial transaction card. In some embodiments, the POS terminal 34 may be a cardholder's personal computer, such as when conducting an online purchase through the Internet. As used herein, the terms POS device, POS terminal, and point of interaction device are used broadly, generally, and interchangeably to refer to any device in which a cardholder interacts with a merchant to complete a payment card transaction.

A database server 36 is connected to a database 38, which is configured to store information on a variety of matters, including the multi-account data as described below in greater detail. In one embodiment, the database 38 is a centralized database stored on the server system 30 and can be accessed by potential users at one of the user systems 32 by logging onto the server system 30 through one of the user systems 32. In an alternative embodiment, the database 38 is stored remotely from the server system 30 and may be a distributed or non-centralized database.

In one example embodiment, the database 38 may include a single database having separated sections or partitions or may include multiple databases, each being separate from each other. The database 38 may store transaction data generated as part of sales activities and savings activities conducted over the processing network including data relating to merchants, account holders or customers, issuers, acquirers, savings amounts, savings account information, and/or purchases made. The database 38 may also store account user identification data including, for example, at least one of a cardholder name, a cardholder address, an account number, and other account identifier. The database 38 may also store merchant data including a merchant identifier that identifies each merchant registered to use the network, and instructions for settling transactions including merchant bank account information. The database 38 may also store financial transaction data including purchase data associated with items being purchased by a cardholder from a merchant, and authorization request data. The database 38 may also store digital wallet data 306, device information, a plurality of PANs and/or at least one virtual PAN, shared account data, limitations associated with the shared account(s), and/or other data involved with providing access to account numbers to one or more parties to the transaction.

In an embodiment, at least one issuer may communicate financial transaction data relating to the plurality of account numbers to the database 38. Further, a plurality of issuers in communication respectively with a plurality of interchange networks may provide financial transaction data for storage in the database 38. Financial transaction data is preferably captured in the database 38 for all transactions conducted via multiple interchange networks and via multiple media types (e.g., via physical payment cards, digital wallet, etc.), as well as for up-to-date account balance(s). In turn, database server 36 may be configured with a database management system for responding to queries by other interchange networks—e.g., via an application programming interface (API)—to provide financial transaction data and facilitate enforcement of transaction limitations on transactions attempted via those other interchange networks. One of ordinary skill will appreciate that multiple data sources may transmit financial transaction data to the database 38, and multiple data recipients may query the database 38 for financial transaction data, to ensure comprehensive tracking of account status and enforcement of limitations within the scope of the present invention.

In the example embodiment, one of the user systems 32 may be associated with the cardholder 22 (shown in FIG. 1) while the POS terminal 34 may be associated with the merchant 12 (shown in FIG. 1) or may be a computer system and/or mobile system used by the cardholder 22 while making an on-line purchase or payment. The server system 30 may be associated with the interchange network 16 or a payment processor. In the example embodiment, the server system 30 is associated with a financial transaction processing network, such as the interchange network 16, and may be referred to as an interchange computer system. The server system 30 may be used for processing transaction data. In addition, the user systems 32 and the POS terminal 34 may include a computer system associated with at least one of a merchant, an online bank, a bill payment outsourcer, an acquirer bank, an acquirer processor, an issuer bank associated with a transaction card, an issuer processor, a remote payment processing system, and/or a biller.

In the example embodiment, the TPS 102 is in communication with the multi-account payment system 26 and the multi-account application 28, which may be associated with the interchange network 16, with an outside third party in a contractual relationship with the interchange network 16, and/or with the user systems 32. For instance, the multi-account payment system 26 may be stored on and accessed from the memory device 304 shown in FIG. 3, and may be intermittently or continuously in communication with the server system 30 to conduct transactions, receive financial transaction data, and otherwise perform the steps outlined herein. In an embodiment, the multi-account payment system 26 may be integral and/or synced for operation in conjunction with the digital wallet 306. The multi-account payment system 26 may periodically query the database 38 to update records in the memory 304 with financial transaction data regarding the plurality of accounts. It is foreseen that a variety of data sources may be utilized to keep records of the memory 304 current with financial transaction data without departing from the spirit of the present invention. Moreover, the multi-account payment system 26 stored locally on the device 300 may continue to function in periods between updates from the database 38, including by tracking financial transaction data generated by transactions conducted via the digital wallet 306 and checking such transactions against limitations based on the best available financial transaction data.

The multi-account payment system 26 receives limitations to be placed on one or more of a plurality of account numbers managed by the multi-account payment system 26. In the example embodiment, the multi-account payment system 26 also receives requests from a primary cardholder, such as a cardholder 22, to link the primary cardholder's PAN and/or virtual PAN with a shared account number for sharing with a secondary cardholder. In addition, the multi-account payment system 26 receives requests from the primary cardholder to add the secondary cardholder to the shared account. The multi-account payment system 26 also receives financial transaction data from the server system 30 to facilitate implementation and enforcement of the limitations.

The primary cardholder is generally a cardholder 22 that holds the shared account number(s) and is ultimately responsible for the debt accrued using the shared account number(s). The primary cardholder may also enjoy primary rights to set the transaction limitations (discussed in more detail below) on the plurality of account numbers, though it is foreseen that the secondary cardholder may be given rights to define transaction limitations for shared account(s) without departing from the spirit of the present invention. In contrast, the secondary cardholder is generally a user 22 that the primary cardholder wants to permit use of the shared account number(s) within restrictions (i.e., transaction limitations) set by the primary cardholder.

In some embodiments, the multi-account payment system 26 and/or the multi-account application 28 are also in communication with a merchant system and/or an issuer system (not shown) and/or the POS terminal 34 of the merchant 12. It is noted that the payment network 100 may include more, fewer, or alternative components and/or perform more, fewer, or alternative actions, including those discussed elsewhere herein.

FIG. 3 is an example configuration of a user computing device 300 operated by a user 301, such as the cardholder 22 (shown in FIG. 1). In some embodiments, the user computing device 300 comprises a user system 32 and/or a merchant POS terminal 34. In the example embodiment, the user computing device 300 includes a processor 302 for executing instructions. In some embodiments, executable instructions are stored in a memory device 304. The processor 302 includes one or more processing units, for example, in a multi-core configuration. The memory device 304 is any device allowing information, executable instructions, and/or written works, such as the digital wallet data 306 and/or multi-account application 28, to be stored and retrieved. The memory device 304 includes one or more computer readable media.

The user computing device 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, such as a liquid crystal display (LCD), organic light emitting diode (OLED) display, or “electronic ink” display, or an audio output device, such as a speaker or headphones.

In some embodiments, the user computing device 300 includes an input device 310 for receiving input from the user 301. The input device 310 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310. The user computing device 300 may also include a communication interface 312, which is communicatively connectable to a remote device such as the server system 30 and/or the POS terminal 34 (shown in FIG. 2). The communication interface 312 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and a client application, such as a digital wallet application and/or a multi-account application. Web browsers enable users, such as the user 301, to display and interact with media and other information typically embedded on a web page or a website from the server system 30. A client application allows the user 301 to interact with a server application—such as a database management application of the database server 36—from the server system 30.

In the exemplary embodiment, the computing device 300 is a user computing device from which the user 301 engages with a digital wallet 306 and/or multi-account application 28, an online merchant (e.g., the merchant 12 shown in FIG. 1), an interchange network (e.g., as represented by server system 30 in FIG. 2), and an issuer of a payment card (e.g., the issuer 18 shown in FIG. 1) to perform a payment transaction using, for example, one of the plurality of accounts managed by the multi-account payment system 26 (e.g., a PAN and/or virtual PAN). Alternatively, rather than using a digital wallet 306, the user 301 may conduct a transaction with a physical payment card associated with one of the plurality of accounts.

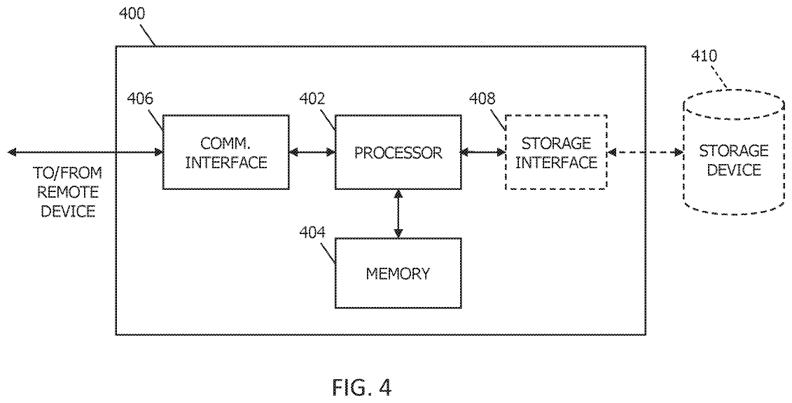

FIG. 4 is an example configuration of a server system 400, such as the server system 30 (shown in FIG. 2). In an embodiment in which the multi-account payment system 26 is not hosted on the user computing device 300, the server system 400 includes, but is not limited to, the database 24 (shown in FIG. 1), the multi-account payment system 26, and/or the multi-account application 28. In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as a user computing device 300 (shown in FIG. 3) or another server system 400. For example, the communication interface 406 may receive communications from a client system 32 via the Internet, as illustrated in FIG. 2.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the database 24. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with operable access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In an example embodiment, the server system 400 is a multi-account payment system in communication with one or more of the user system 32 (shown in FIG. 2), the interchange network 16, and/or the merchant 12 during a payment card transaction involving the digital wallet 306 (shown in FIG. 3) of a user, such as the cardholder 22 (shown in FIG. 1). The server system 400 performs checking for account information updates and/or limitations for accounts initiating a payment transaction. In alternative embodiments, the payment card transaction may include a physical payment card that is read by the POS device 34 (shown in FIG. 2) rather than the digital wallet 306.

In the example embodiments, the multi-account payment system 26 is programmed to communicate with one or more client systems 32 to receive user identification data to facilitate activating user(s), such as the primary user and the secondary user, that are not registered with the multi-account payment system 26. In particular, the user activation process creates a user account and associated credentials for use with the multi-account payment system 26 and/or the multi-account application 28. The user(s), such as the primary user and the secondary user, enter the user identification data, which is provided to the multi-account payment system 26. The user identification data may include, for example, and without limitation, personal data relating to the identity of the user(s). Specifically, the identification data may include personal identifying information of the user(s), such as a user's name, email address, password, cellular phone number, etc. The user identification data is stored in the database 24. The multi-account payment system 26 generates a user account from the user identification data for the user.

The multi-account payment system 26 may be integrated within and/or may otherwise allow for communication with the digital wallet 306 (shown in FIG. 3) to send, receive, and store information related to, for example, and without limitation, the plurality of accounts, limitations set by transaction types and/or cardholder(s), notifications of transactions made though one or more of the plurality of account numbers, notifications indicating that transactions have neared one or more of the limitation(s), etc.

In the exemplary embodiment, the primary cardholder may establish a shared account number and may link one or more PANs and/or virtual PANs to the shared account number. After establishing the shared account number, the primary cardholder may invite the secondary cardholder to link to the shared account number. For example, and without limitation, the primary cardholder may choose a secondary cardholder having a user account with the multi-account payment system 26, using for example, the multi-account application 28. The secondary cardholder may receive a notification that a shared account number is available for his/her use. Alternatively, in some embodiments, the primary cardholder may send a message, such as an SMS message, to the secondary cardholder notifying them that a shared account number is available for use. If the secondary cardholder does not have a user account with the multi-account payment system 26, the secondary cardholder may establish the user account and access the shared account number. In such an example, the SMS message may include a link or other identifier, identifying the shared account number established by the primary cardholder.

The primary cardholder (and, optionally, the secondary cardholder) may establish one or more limitations for the shared account number, as described herein, and store those limitations in the multi-account payment system 26. Moreover, the primary cardholder may establish one or more limitations for other of the plurality of account numbers managed by the multi-account payment system 26. Each limitation may be established, for example, by specifying restrictions or approvals of the use of one or more of the plurality of account numbers.

In the exemplary embodiments, the limitations can be based on, for example, and without limitation, cardholder, time limit, spending amount, geolocation of the user system 32, Merchant Category Codes (MCCs), merchant names, and/or other merchant identifiers. The aforementioned aspects of transactions may be grouped or otherwise configured into budget categories managed by the multi-account payment system 26 and/or the digital wallet 306. For instance, transactions having any of a first group of MCCs may be limited to a first dollar amount during a first time interval, and transactions having any of a second group of MCCs may be limited to a second dollar amount during the first time interval. Simultaneously, a first cardholder may be restricted by a first total transaction limit applicable to all of the plurality of account numbers, whereas a second cardholder may be restricted by a second total transaction limit applicable to all of the plurality of account numbers.

In one embodiment, MCCs, merchant names, and/or other merchant identifiers used to limit transactions may be assigned to selected types of merchants, such as grocery store, liquor stores, clothing stores, restaurants, and the like, or they may be assigned to specific stores within the selected types of stores. Therefore, when a cardholder uses the digital wallet 306 as a payment device at a merchant 12 to make a transaction, the POS device 34 of the merchant 12 sends an MCC identifier and/or another merchant identifier (e.g., a merchant ID) to the interchange network 16 and the multi-account payment system 26 in an authorization message. The multi-account payment system 26 checks the MCC against a list of limitations governing the spending of the cardholder. The multi-account payment system 26 declines the transaction if it violates a limitation and allows the transaction if it does not. Furthermore, in some suitable embodiments, the limitations may include a spending limit, a time limit, and/or a geolocation limit. If any of the limitations are violated, the transaction is declined by the multi-account payment system 26. As such, the multi-account payment system 26 facilitates the cardholder or cardholders' control over the types and amounts of transactions that occur using the plurality of account numbers.

Still further, one or more of the cardholders authorized for use of account number(s) of a user account may be permitted to relate transaction types to form a single limitation. For example, a secondary cardholder may be limited from purchasing in excess of $200 in goods per month from cosmetic stores (MCC 5977) unless department store (MCC 5311) purchases are below $100 that month. For another example, the primary cardholder may limit airline purchases to $5,000 per year across all of a plurality of accounts, and require that all airline purchases be made with one of the plurality of accounts (for example, to obtain associated rewards). For still another example, all entertainment-related transactions may be limited to no more than $500 per month unless there are no airline transactions recorded for the month. In this manner, spending limits on one transaction type may be contingent on spending of another transaction type. Any transaction that would cause violation of such a combined limitation may be declined and a corresponding notification may be generated and provided to the user system(s) 32. Similarly, transaction types may be pooled to provide more general spending limits, such as where airline, entertainment, and food transactions for a month are not to exceed $1,200 in a month.

Furthermore, when a cardholder makes a transaction at a POS terminal 34, for example, the transaction data is checked against the multi-account payment system 26 by the interchange network 16, and the multi-account payment system 26 accepts or denies the transaction depending on the limitations that the cardholder(s) have put on the use of the plurality of account numbers. When a cardholder makes a transaction via the digital wallet 306 on a user system 32 that includes the multi-account payment system 26, merchant financial transaction data stored by the user system 32 may be checked against the limitations, and the multi-account payment system 26 accepts or denies the transaction accordingly.

In some embodiments, the multi-account application 28 may generate and/or send notifications to one or more of the cardholders regarding transactions, including for example, whether a transaction violated one or more limitations or brought the cardholders within a pre-defined proximity to a limitation. The multi-account payment system 26 allows the primary cardholder to access the plurality of account numbers through the multi-account application 28 on the multi-account payment system 26 and/or through the primary cardholder's digital wallet 306 on the client system 32, to view any limitations associated with the account numbers. Similarly, the multi-account payment system 26 allows the secondary cardholder to access the shared account number(s) through the multi-account application 28 on the multi-account payment system 26 and/or through the secondary cardholder's digital wallet 306 on the client system 32, to view any limitations associated with the shared account number(s).

In the exemplary embodiments, the multi-account application 28 allows a cardholder to create, edit, and view the limitations by accessing the multi-account payment system 26, for example, and without limitation, via a user computing device 300 (shown in FIG. 3) and/or the user system 32 (shown in FIG. 2) via the digital wallet 306, a mobile application, and/or via a web browser (not shown). In the exemplary embodiment, a shared account number and the limitations associated therewith are transferred to a secondary cardholder's digital wallet 306. The secondary cardholder may view the limitations in the digital wallet 306 and may use the digital wallet 306 to transmit the shared account number information to a merchant 12, for example, via the POS device 34. For example, the secondary cardholder may enter into a transaction by placing the user system 32 (i.e., a smartphone, PDA, or the like) near the POS device 34 to facilitate transmission of the shared account number data to the POS device 34. Alternatively, the shared account number and the associated limitations are accessible to a physical payment card associated with the shared account. The primary cardholder may similarly engage in transactions using any of the plurality of account numbers by a variety of means (e.g., using a physical card, user system 32 and/or user computing device 300).

In the exemplary embodiment, the multi-account application 28 allows a cardholder to edit the limitations (e.g., change spending limits, time limits, add or remove secondary cardholders, etc.) at any time after the user account is established. Any changes made to the limitations may be transmitted automatically to any secondary cardholder's digital wallet 306 for shared account number(s) and/or are automatically applied to the physical payment card associated with the shared account. Furthermore, the cardholder may cancel any account number (including any shared account number) at any time. In an embodiment, the cardholder may designate “control groups” comprising groupings of account numbers, and may associate limitations with each group according to preference. For instance, the default setting of the multi-account application 28 may treat addition of an account number to the user account as a designation of the account number for control by the multi-account application 28 in a common group (consisting of all account numbers in the user account). The cardholder may optionally delineate from among the plurality of account numbers to further designate sub-groups for different treatment under the established limitations.

Furthermore, in other embodiments, the cardholder may choose to manually allow a transaction. For example, if a large purchase is anticipated, the cardholder may choose to be notified via a notification when the transaction is being attempted. The cardholder may then be given the option to deny or allow the transaction to continue, for example, via the multi-account application 28 and/or the cardholder's digital wallet 306.

In a preferred embodiment, the primary cardholder may utilize the multi-account payment system 26 as a budgeting tool that tracks transactions across multiple account numbers and directly intervenes to preclude over-budget transactions that violate established limitations. The digital wallet 306 may be configured to present the user 301 with one or more budgeting visualization tools via the media output 308. For instance, the user 301 may select one or more transaction types and/or cardholders that should be subject to a limitation—for example, from a list and/or drop-down menu. The digital wallet 306 may display transaction histories and/or a variety of limitation types or groupings that may be applied to form the limitation in the form of visualization tools such as timelines, pie charts, heat charts, or the like. The digital wallet 306 may also be configured to present recommended transaction and/or budgeting limitations in the form of visualization tools. For instance, the digital wallet 306 may be configured to ask the user for fundamental financial information—such as net income, set expenses, etc.—and to utilize pre-configured financial models to present recommended limitations for use with the account numbers. In an embodiment, the digital wallet 306 may be configured to present a recommended distribution of expenditures (e.g., across “mortgage, insurance, entertainment,” and other categories) in the form of a pie chart in which each slice corresponds to a category.

The user 301 may manipulate the aspects of the proffered budget visualization tools—for example by providing input at a touch screen of the input device 310—to set the limitations according to personal preference. For instance, where a pie chart of expense categories is the budget visualization tool presented, the user 301 may select a border between two “slices” and drag same in a direction to adjust the relative size of each “slice” and correspondingly change associated limitations on transactions for the account numbers. Transaction limitations may also be set through manual selection of transaction types, cardholders and/or limitation types and entry of associated value(s) or spending ceilings.

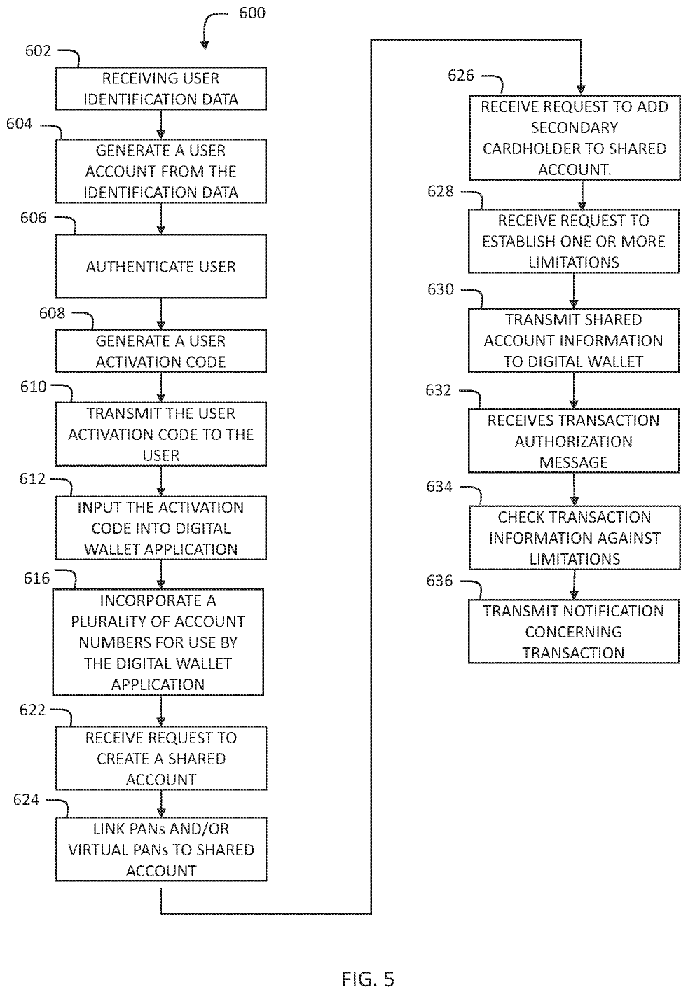

FIG. 5 shows a flow chart of an example method 600 for receiving and implementing limitations placed on a plurality of account numbers associated with the user account of a primary cardholder. The example method 600 also includes sharing a primary cardholder's primary account number (PAN) with a secondary cardholder. In the example embodiment, the method 600 is implemented by the multi-account payment system 26.

In the example method 600, an operation 602 includes receiving user identification data to facilitate activating a user—such as the primary user or the secondary user—that is not registered with the multi-account payment system 26. For example, when a user, such as the primary user or the secondary user, signs up for a user account on the multi-account payment system 26, the multi-account payment system 26 requests certain identification data from the user in order to generate the user account. The user identification data may be stored in the database 24. The method 600 includes an operation 604 that includes generating the user account at least in part based on the user identification data for each respective user.

After the user account is created and the user (e.g., the primary or secondary cardholder) has been setup or onboarded with the multi-account payment system 26, the method 600 proceeds with authenticating the user according to known user authentication techniques. In the example embodiment, an operation 608 generates a user activation code upon authentication. The multi-account payment system 26 then transmits the user activation code to the user via the user's email address at operation 610.

In the example method 600, at operation 612, the user inputs the activation code into the user's digital wallet application 306 installed, for example, on the client system 32, such as the user's cellular phone or a computer. At operation 616, the user incorporates a plurality of account numbers for use through the digital wallet 306, according to known techniques.

At operation 622, the multi-account payment system 26 receives a request from the user, such as the primary cardholder, to create a shared account number from among the plurality of accounts managed by the digital wallet 306 and registered in the user account. The primary cardholder may link one or more PANs and/or virtual PANs to the shared account number at operation 624.

At operation 626, the multi-account payment system 26 receives a request to add a secondary cardholder to the shared account number. As described herein, the secondary cardholder may receive a notification that the shared account number is available for use.

At operation 628, the multi-account payment system 26 receives a request from the primary cardholder to establish one or more limitations for an account of the plurality of accounts. The limitations may be established, for example, through budget visualization tools displayed to the user via the media output 308 which may include and/or reflect one or more budget recommendation(s). The primary cardholder may select or otherwise define one or more transaction limitations governing transactions conducted via one or more of the plurality of account numbers. For instance, the limitations may be established by specifying restrictions or approvals of the use of the shared account number by the secondary cardholder.

As described above, the limitations can be based on, for example, and without limitation, time limit, spending amount, geolocation of the user system 32, Merchant Category Codes (MCCs), merchant names, and/or other merchant identifiers. The multi-account payment system 26 stores the limitations that are established by the primary cardholder, for example, in database 24.

At operation 630, the multi-account payment system 26 transmits the shared account information, e.g., the linked PANs and/or virtual PANs, to the secondary cardholder's digital wallet 306. Alternatively, the multi-account payment system 26 associates a physical payment card with the shared account number.

At an operation 632, the multi-account payment system 26 receives a transaction authorization message. The multi-account payment system 26 checks transaction information contained in the authorization message against the limitations established for the account numbers of the user account at operation 634. In an embodiment, the database 24 contains up-to-date information regarding all previous transactions and account balances for the plurality of account numbers, permitting all previous transactions and the current proposed transaction authorization message to be compared against the limitations in real-time. The multi-account payment system 26 declines the transaction if it is determined that the transaction violates a limitation imposed on the account numbers and allows the transaction if it is determined that it does not.

At operation 636, the multi-account application 28 transmits notifications to the primary cardholder including details of transactions made via one of the account numbers of the user account, including for example, whether a transaction violated one or more limitations. In one embodiment, the notifications may include an authorization request. In such an embodiment, the primary cardholder may choose to manually allow a transaction in violation of one or more limitations. As such, the multi-account payment system 26 receives authorization for the transaction from the primary cardholder and allows the transaction to continue.

Any actions, functions, operations, and the like recited herein may be performed in the order shown in the figures and/or described above or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present disclosure.

A computer-readable storage media or medium comprising a non-transitory medium may include an executable computer program stored thereon and for instructing one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are example only and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the disclosure has been described with reference to the one or more embodiments illustrated in the figures, it is understood that equivalents may be employed, and substitutions made herein without departing from the scope of the disclosure as recited in the claims.

Having thus described one or more embodiments of the disclosure, what is claimed as new and desired to be protected by Letters Patent includes the following:

1. A multi-account payment system for controlling transaction authorization(s), said multi-account payment system comprising:
a memory device for storing data; and
a processor communicatively coupled to said memory device, said processor programmed to:
receive a designation of a plurality of account numbers associated with a primary cardholder for control by a multi-account application of the multi-account payment system,
receive a request from the primary cardholder to create one or more limitations on the use of the plurality of account numbers,
store the plurality of account numbers and the one or more limitations in the memory device,
receive a transaction authorization message associated with a transaction by one of the plurality of account numbers,
determine whether the transaction violates at least one of the one or more limitations, and
decline the transaction if one or more of the limitations are violated.

2. The multi-account payment system in accordance with claim 1,
said processor programmed to receive a request from the primary cardholder to add a secondary cardholder to a shared account number.

3. The multi-account payment system in accordance with claim 2,
said processor programmed to transmit a notification to the secondary cardholder that the shared account number is ready for use.

4. The multi-account payment system in accordance with claim 3, wherein the transaction is by the shared account number and is initiated by the secondary cardholder.

5. The multi-account payment system in accordance with claim 1,
said processor programmed to transmit a notification to the primary cardholder including details of the transaction.

6. The multi-account payment system in accordance with claim 5,
said notification including whether the transaction violated at least one of the one or more limitations.

7. The multi-account payment system in accordance with claim 1, wherein the one or more limitations includes one or more of the following: a time limit, a spending amount, a geolocation for use of the plurality of account numbers, a merchant category code, and a merchant name.

8. The multi-account payment system in accordance with claim 1,
said processor programmed to transmit a notification to the primary cardholder requesting authorization of the transaction by the primary cardholder.

9. The multi-account payment system in accordance with claim 1,
said processor programmed to receive a request to modify the one or more limitations.

10. The multi-account payment system in accordance with claim 1, wherein the transaction authorization message is received from a digital wallet.

11. A computer-implemented method for controlling transaction authorization(s), said method comprising:
receiving designation of a plurality of account numbers associated with a primary cardholder for control by a multi-account application of the multi-account payment system,
receiving a request from the primary cardholder to create one or more limitations on the use of the plurality of account numbers,
storing the plurality of account numbers and the one or more limitations in the memory device,
receiving a transaction authorization message associated with a transaction by one of the plurality of account numbers,
determining whether the transaction violates at least one of the one or more limitations, and
declining the transaction if one or more of the limitations are violated.

12. The computer-implemented method of claim 11,
further comprising receiving a request from the primary cardholder to add a secondary cardholder to a shared account number.

13. The computer-implemented method of claim 12,
further comprising transmitting a notification to the secondary cardholder that the shared account number is ready for use.

14. The computer-implemented method of claim 13, wherein the transaction is by the shared account number and is initiated by the secondary cardholder.

15. The computer-implemented method of claim 11,
further comprising transmitting a notification to the primary cardholder including details of the transaction.

16. The computer-implemented method of claim 15,
said notification including whether the transaction violated at least one of the one or more limitations.

17. The computer-implemented method of claim 11, wherein the one or more limitations includes one or more of the following: a time limit, a spending amount, a geolocation for use of the plurality of account numbers, a merchant category code, and a merchant name.

18. The computer-implemented method of claim 11,
further comprising transmitting a notification to the primary cardholder requesting authorization of the transaction by the primary cardholder.

19. The computer-implemented method of claim 11,
further comprising receiving a request to modify the one or more limitations.

20. The computer-implemented method of claim 11, wherein the transaction authorization message is received from a digital wallet.
